(19) United States
(12) Patent Application Publication
(10) Pub. No.: US 2014/0056394 A1
(43) Pub. Date: Feb. 27, 2014

(54) SIGNAL DETECTOR DEVICE AND SIGNAL DETECTION METHOD

(71) Applicant: Panasonic Corporation, Osaka (JP)

(72) Inventors: Hiroshi Takahashi, Kanagawa (JP); Yoshio Urabe, Kanagawa (JP); Kazuhiro Ando, Kanagawa (JP); Naoto Oka, Kanagawa (JP); Masataka Irie, Kanagawa (JP)

(73) Assignee: Panasonic Corporation, Osaka (JP)

(21) Appl. No.: 14/114,168

(22) PCT Filed: Mar. 12, 2013
(86) PCT No.: PCT/JP2013/001609

§ 371 Date: Oct. 25, 2013

(30) Foreign Application Priority Data
Mar. 15, 2012 (JP) 2012-058608
Mar. 23, 2012 (JP) 2012-067343

(51) Int. Cl. H04L 7/04

(52) U.S. Cl. CPC H04L 7/042
USPC 375/343

(57) ABSTRACT

In a signal detection apparatus, power detection section 101 detects power of an inputted received signal, and upon detection of power exceeding a power detection threshold, outputs a trigger to storage section 102. Storage section 102 stores a first received signal upon reception of the trigger and outputs the stored first received signal to multiplier 103 and newly stores a second received signal upon receipt of the next trigger. Multiplier 103 multiplies the second received signal by the first received signal, integrator 104 integrates the multiplication result from multiplier 103 during a predetermined duration to obtain a correlation value of the second and first received signals, and absolute value calculation section 105 calculates an absolute value of the correlation value from integrator 104. Determination section 106 determines the presence/absence of a detection-target signal based on the absolute value of the correlation value from absolute value calculation section 105.

### TECHNICAL FIELD

The present invention relates to a signal detection apparatus and a signal detection method for detecting signals of other systems.

### BACKGROUND ART

In recent years, in millimeter-wave wireless communication using a 60 GHz band, a plurality of wireless communication standards have been developed and studied. Main wireless local area network (LAN)/wireless personal area network (PAN) standards which do not require a license include wireless gigabit (WiGig), IEEE 802.15.3c, Wireless high definition (HD), and ECMA-387. The development of the IEEE 802.11ad standard is also in progress.

In each standard, a plurality of radio systems (for example, a single carrier system and an orthogonal frequency division multiplexing (OFDM) system) according to a target application coexist.

The systems respectively corresponding to a plurality of wireless communication standards coexist, and a plurality of wireless systems also coexist in each of the systems.

When millimeter-wave wireless communication comes into wide use, it is assumed that there are many situations in which a plurality of different wireless systems are used proximately. For this reason, the systems use different frequency channels, thereby making it possible to perform communication simultaneously in the same space.

However, because the number of frequency channels available in the 60 GHz band is limited to three to four channels, when millimeter-wave wireless communication comes into wide use, it is expected that a plurality of different systems use the same frequency channel. As a result, inter-system interference occurs, and there is concern that communication performance in each system is degraded.

In order to avoid the interference, first, it is necessary to detect an interference signal from a different system with respect to a target system. Heretofore, as a signal detection method, carrier sense by power (hereinafter, simply referred to as “carrier sense”) is widely used. Carrier sense is a method which detects power to detect a signal.

Specifically, in carrier sense, power of a received signal is measured, and when the measured power value exceeds a predetermined threshold, it is recognized that a signal is detected. Carrier sense has a feature that a signal can be detected regardless of the types of systems.

As carrier sense, for example, technology disclosed in Patent Literature (hereinafter, abbreviated as “PTL”) 1 is known. PTL 1 proposes a method in which: in carrier sense of clear channel assessment (CCA) of IEEE 802.11, for example, if power (level) exceeds a predetermined threshold, it is determined to be a busy state representing that a transmission medium is in use; even if power does not exceed the predetermined threshold, the state transitions to a pending state in which determination on whether or not the transmission medium is in use is in progress; and if a preamble is detected in the pending state, it is determined to be the busy state. Accordingly, the signal of power which does not exceed the predetermined threshold can also be detected.

### CITATION LIST

### Patent Literature

PTL 1

Japanese Patent Application Laid-Open No. 2010-28750

### SUMMARY OF INVENTION

### Technical Problem

However, in the technology disclosed in PTL 1, although a signal of low power can be detected, when noise in excess of a predetermined threshold is detected, the noise is wrongly detected as a signal because noise cannot be distinguished from signals. Accordingly, the technology disclosed in PTL 1 has a problem in that there is no improvement in the power detection sensitivity.

That is, if the predetermined threshold is set to be low in order to improve detection sensitivity, noise is likely to be wrongly detected as a signal. Meanwhile, if the predetermined threshold is set to be high in order to prevent wrong detection, there is no improvement in the problem of deterioration in detection sensitivity in carrier sense.

An object of the invention is to provide a signal detection apparatus and a signal detection method which reduce wrong detection of noise as a signal and which improve power detection sensitivity.

### Solution to Problem

A signal detection apparatus according to an aspect of the present invention includes: a power detection section that detects a received signal of reception power exceeding a predetermined first threshold; a correlation value calculation section that calculates a correlation value of the detected first received signal and a second received signal detected next to the first received signal; an absolute value calculation section that calculates an absolute value of the calculated correlation value; and a determination section that determines the presence or absence of a detection-target signal based on a threshold determination of the calculated absolute value of the correlation value and a predetermined second threshold.

A signal detection method according to an aspect of the present invention includes: detecting reception power exceeding a predetermined first threshold; calculating a correlation value of a first received signal of the detected reception power and a second received signal of reception power detected next to the first received signal; calculating an absolute value of the calculated correlation value; and determining the presence or absence of a detection-target signal based on a threshold determination of the calculated absolute value of the correlation value and a predetermined second threshold.

### Advantageous Effects of Invention

According to the invention, it is possible to reduce wrong detection of noise as a signal and to improve power detection sensitivity.

### BRIEF DESCRIPTION OF DRAWINGS

FIG. 1 is a diagram showing the configuration of a signal detection apparatus according to Embodiment 1 of the invention;

FIG. 2 is a diagram illustrating the operation of the signal detection apparatus shown in FIG. 1;

FIG. 3 is a diagram illustrating the operation of a signal detection apparatus according to Embodiment 2 of the invention;

FIG. 4 is a diagram illustrating the operation of a signal detection apparatus when one beacon in each beacon group is determined to be a received signal;

FIGS. 5A and 5B are diagrams illustrating the operation of an autocorrelation detector disclosed in PTL 2;

FIGS. 6A and 6B are diagrams illustrating a general autocorrelation method;

FIG. 7 is a block diagram showing the configuration of a signal detection apparatus according to an embodiment of the invention; and

FIG. 8 is a diagram illustrating a signal detection operation of the signal detection apparatus shown in FIG. 7.

### DESCRIPTION OF EMBODIMENTS

Hereinafter, embodiments of the invention will be described in detail referring to the drawings.

In the embodiment of the present invention, it is assumed a situation in which a plurality of communication systems respectively corresponding to a plurality of millimeter-wave wireless communication standards are mixed. In each communication system, a transmitting apparatus (for example, an access point) maps a periodic signal configured in each communication system to a preamble portion and transmits the periodic signal.

A signal detection apparatus according to the embodiment is installed in a receiving apparatus (for example, a terminal apparatus) which communicates with any communication system from among the plurality of communication systems and detects a frame from the communication system with which the installed receiving apparatus communicates (hereinafter, referred to as “host system”).

Hereinafter, although a description will be provided assuming that the signal detection apparatus detects the frames of a plurality of different systems, a frame of the host system may be included in the detection-target frames.

### Embodiment 1

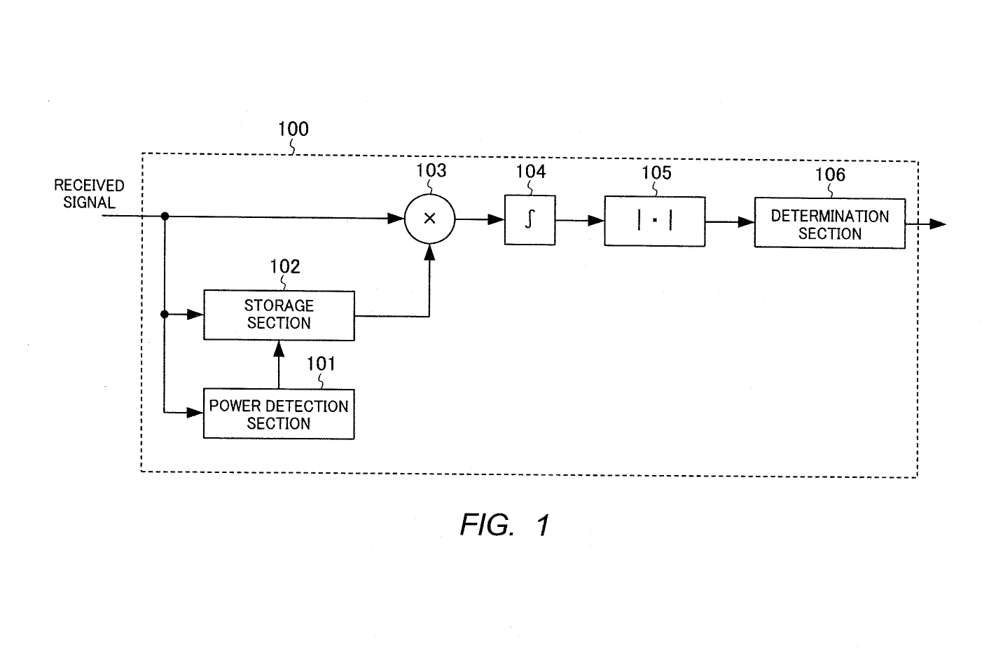

FIG. 1 is a diagram showing the configuration of signal detection apparatus 100 according to Embodiment 1 of the invention. Hereinafter, the configuration of signal detection apparatus 100 will be described referring to FIG. 1.

In FIG. 1, signal detection apparatus 100 includes power detection section 101, storage section 102, multiplier 103, integrator 104, absolute value calculation section 105, and determination section 106.

Signal detection apparatus 100 receives a received signal, that is, a baseband signal as input, the received signal being obtained after a radio received signal received through an antenna in a receiving apparatus is subjected to radio reception processing (such as down-conversion and analog-digital conversion). The inputted received signal is distributed (copied), and a plurality of distribution signals are inputted to power detection section 101, storage section 102, and multiplier 103.

Power detection section 101 detects power of the inputted received signal, and upon detection of power exceeding a power detection threshold, outputs a trigger to storage section 102.

When a trigger is outputted from power detection section 101, storage section 102 stores the inputted received signal as a first received signal. When the next trigger is outputted from power detection section 101, storage section 102 outputs the stored first received signal to multiplier 103, and stores the newly inputted received signal as a second received signal.

Multiplier 103 multiplies the inputted second received signal by the first received signal outputted from storage section 102, and outputs the multiplication result to integrator 104.

Integrator 104 integrates the multiplication result outputted from multiplier 103 for a predetermined duration, and outputs the integral result (that is, a correlation value of the second received signal and the first received signal) to absolute value calculation section 105. Multiplier 103 and integrator 104 function as a correlation value calculation section.

Absolute value calculation section 105 calculates an absolute value of the correlation value outputted from integrator 104, and outputs the absolute value to determination section 106.

Determination section 106 determines the presence/absence of a detection-target signal on the basis of the absolute value of the correlation value outputted from the absolute value calculation section 105. Specifically, if the absolute value of the correlation value is equal to or greater than a signal detection threshold, determination section 106 determines that a detection-target signal is detected. If the absolute value of the correlation value is smaller than the signal detection threshold, it is determined that no detection-target signal is detected, that is, the first received signal and/or the second received signal is noise.

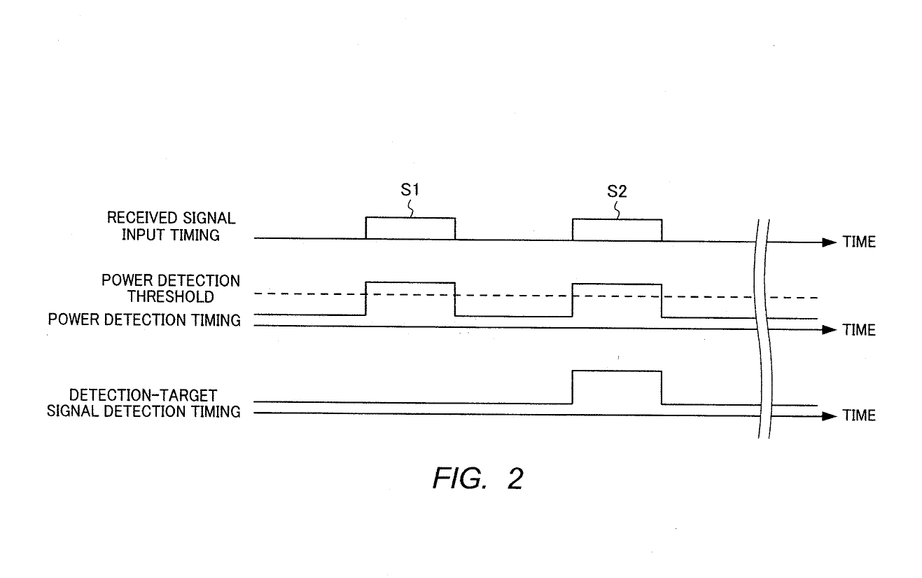

Next, the operation of signal detection apparatus 100 having the above-described configuration will be described referring to FIG. 2. FIG. 2 shows a received signal input timing, a power detection timing, and a detection-target signal detection timing.

Upon detection of power of first received signal 51 exceeding the power detection threshold by power detection section 101, storage section 102 stores first received signal S1.

Subsequently, if power detection section 101 detects that power of second received signal S2 next to first received signal S1 exceeds the power detection threshold, storage section 102 outputs stored first received signal S1 to multiplier 103, and stores second received signal S2. At this time, it is unknown whether second received signal S2 is the detection-target signal or noise.

Second received signal S2 inputted to signal detection apparatus 100 is multiplied by first received signal S1 outputted from storage section 102 by multiplier 103. The multiplication result of multiplier 103 is then integrated by integrator 104, and the correlation value of second received signal S2 and first received signal S1 is obtained.

Absolute value calculation section 105 calculates the absolute value of the correlation value obtained by integrator 104, and if the correlation value is equal to or greater than the signal detection threshold, determination section 106 determines that second received signal S2 is a detection-target signal. If the correlation value is smaller than the signal detection threshold, determination section 106 determines that first received signal S1 and/or second received signal S2 is noise.

In power detection section 101, when second received signal S2 exceeding the power detection threshold is noise, since the correlation value of first received signal S1 and second received signal S2 decreases, and does not exceed the signal detection threshold in determination section 106, it is possible to reduce the frequency of wrong detection of noise as a signal. For this reason, the power detection threshold of power detection section 101 is set to be low, thereby improving the power detection sensitivity.

Signal detection apparatus 100 sets the power detection threshold to be low so as to improve the power detection sensitivity, and excludes, by detection determination processing using autocorrelation, wrong detection of noise which is more likely to occur because of the low power detection threshold. Accordingly, it is possible to achieve both reduction of wrong detection of noise and improvement of power detection sensitivity.

Upon detection of an interference signal from a different system by signal detection apparatus 100, the receiving apparatus including signal detection apparatus 100 starts an operation to avoid interference according to the detected power or the detection frequency. Examples of the operation to avoid interference include changing the frequency channel or transmission timing, and controlling transmission power or antenna directivity.

According to Embodiment 1, each time a received signal of power exceeding the power detection threshold is detected, the correlation value with the received signal detected last time is calculated, and whether or not the received signal is a detection-target signal is determined on the basis of comparison in size between the calculated correlation value and the signal detection threshold. It is thereby made possible to reduce wrong detection of noise as being a signal and to improve the power detection sensitivity.

### Embodiment 2

Millimeter-wave wireless communication has a feature that antenna directivity control (hereinafter, referred to as “beam-forming”) is performed. An access point of a different system transmits beacon frames (for example, including time information of a wireless system) at an interval equal to or smaller than 1 us (1 us in WiGig and 0.5 us in IEEE 802.15.3c) for beam-forming, and cyclically transmits a beacon frame group including some beacon frames. For this reason, it is difficult for signal detection apparatus 100 to receive a plurality of beacon frames subjected to beam-forming, with constant power.

In the embodiment of the invention, a case where a beacon frame subjected to beam-forming is received will be described. The configuration of the signal detection apparatus according to Embodiment 2 of the invention is the same as the configuration of Embodiment 1 shown in FIG. 1, and thus description thereof will be provided appropriately referring to FIG. 1.

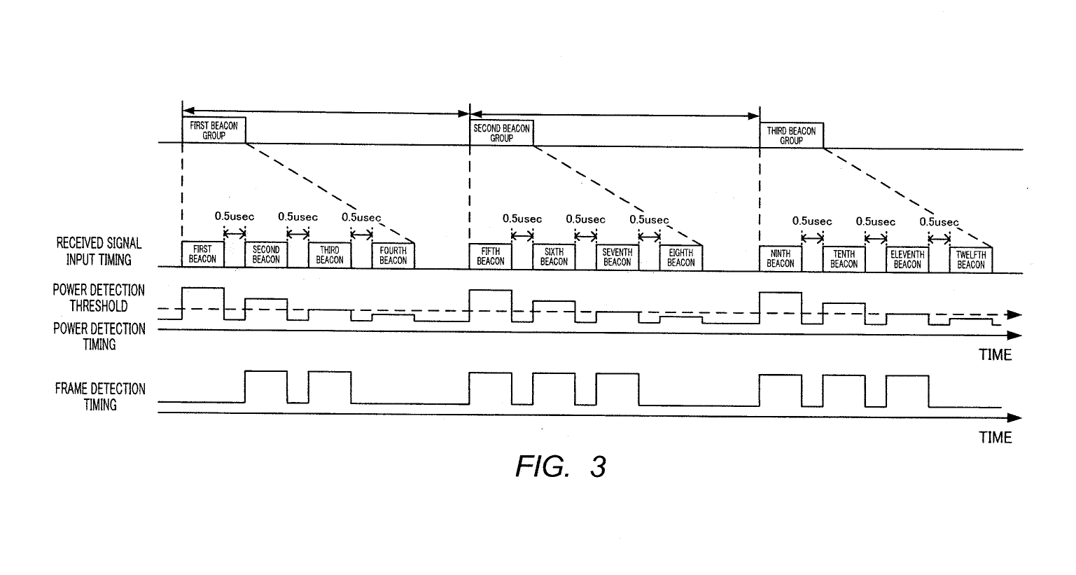

The operation of signal detection apparatus 100 when a beacon frame subjected to beam-forming is received will be described referring to FIG. 3. FIG. 3 shows a received signal input timing, a power detection timing, and a frame detection timing.

Signal detection apparatus 100 receives beacon groups each including four beacons subjected to beam-forming In this case, first to third beacon groups are received. In FIG. 3, first to fourth beacons in the first beacon group to be received by signal detection apparatus 100 are different in reception power.

In FIG. 3, for the first beacon, the second beacon, and the third beacon, the power is equal to or greater than the power detection threshold. Accordingly, power detection section 101 determines that there is a received signal. For the fourth beacon, since the power is smaller than the power detection threshold, power detection section 101 determines that there is no received signal. Similarly, the presence/absence of a received signal is determined for the fifth to eighth beacons in the second beacon group and for the ninth to twelfth beacons in the third beacon group.

Signal detection apparatus 100 takes the correlation between the first beacon and the second beacon using multiplier 103, integrator 104, and absolute value calculation section 105, and detects a frame in determination section 106.

Similarly, signal detection apparatus 100 performs a correlation operation between the second beacon and the third beacon, and detects frames. Signal detection apparatus 100 performs a correlation operation between the third beacon and the fifth beacon over the beacon groups, and detects a frame. Hereinafter, the same operation is performed. In this case, since it is assumed that a signal exceeding the power detection threshold is a beacon, the inputted correlation value becomes equal to or greater than the signal detection threshold, determination section 106 can detect a frame.

Beacons are transmitted by repeatedly using the same signal, so that autocorrelation operation is possible between beacons which are different in power detection level due to beam-forming. It is thus made possible to improve the frame detection precision.

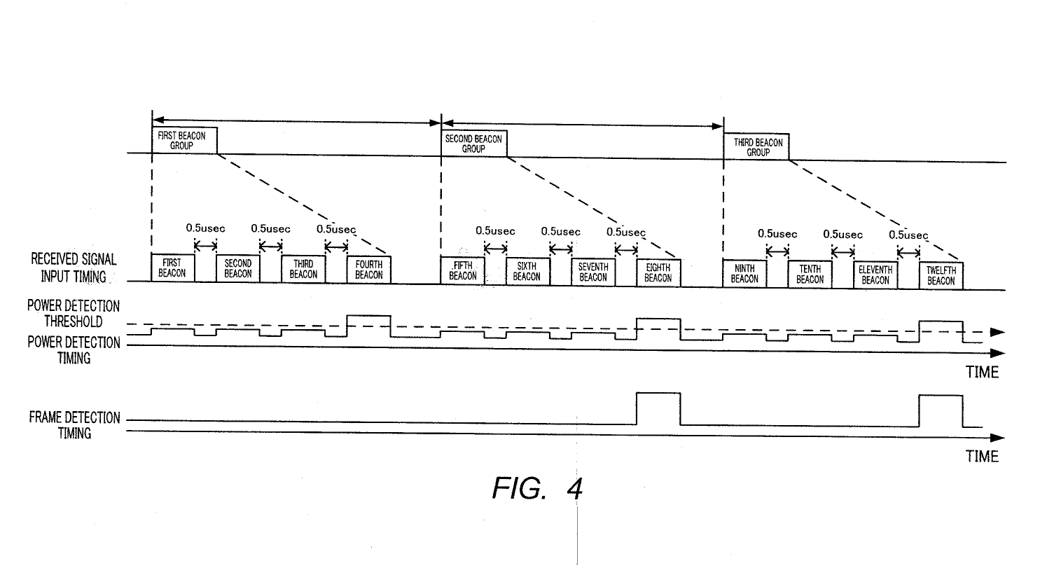

Next, a description will be given, with reference to FIG. 4, of a case where there is a received signal exceeding the power detection threshold for one beacon in each beacon group. FIG. 4 shows a received signal input timing, a power detection timing, and a frame detection timing.

In FIG. 4, in the first to third beacon groups, a fourth beacon, an eighth beacon, and a twelfth beacon exceed the power detection threshold. For this reason, it is difficult for signal detection apparatus 100 to take a correlation in each of the beacon groups.

Accordingly, signal detection apparatus 100 performs a correlation operation between the fourth beacon of the first beacon group and the eighth beacon of the second beacon group, and detects a frame.

Even if one beacon exceeds the power detection threshold in each beacon group, it is possible to improve the frame detection precision because a correlation operation between the beacons over the beacon groups is possible.

According to Embodiment 2, if a detection-target signal is set to a beacon frame in which the same signal is repeatedly transmitted, even in beacon frames which are different in power detection level due to beam-forming, a frame can be detected with high precision by the signal detection apparatus of Embodiment 1.

### Embodiment 3

### <Background of Embodiment 3>

As described in the background art, systems respectively corresponding to a plurality of wireless communication standards coexist, and a plurality of wireless systems coexist in each system. When millimeter-wave wireless communication comes into wide use, it is expected that there are many situations in which a plurality of different wireless systems are used proximately. For this reason, there is demand that the systems use different frequency channels, thereby making it possible to perform communication simultaneously in the same space

However, since it is assumed that the number of frequency channels available in the 60 GHz band is three to four channels, when millimeter-wave wireless communication comes into wide use, there is a possibility that a plurality of different systems use the same frequency channel. For this reason, inter-system interference occurs, and there is concern that communication performance in each system is degraded.

In order to avoid the interference, first, it is necessary to detect an interference signal from a different system with respect to a target system. In the related art, for example, carrier sense by power (hereinafter, simply referred to as “carrier sense”) disclosed in PTL 2 is widely used as a signal detection method in a wireless LAN system. Carrier sense is a method which detects power to detect a signal.

PTL 2

Japanese Patent Application Laid-Open No. 2004-221940

NPL 1

IEEE Std 802.11-2007

In each of a plurality of wireless communication standards involved in the above-described millimeter-wave wireless communication, a signal pattern of a periodic signal for use in a preamble portion is determined. A preamble is detected using signal correlation, making it possible to detect a signal with higher detection sensitivity than carrier sense.

In signal detection of a host system, a method which detects a preamble by cross-correlation between a known signal pattern in the preamble and a received signal is used. Meanwhile, in order to detect an interference signal from a different system, it is necessary for a reception-side apparatus to evaluate all cross-correlations with signal patterns of a plurality of wireless communication standards. Accordingly, the method using cross-correlation is not necessarily appropriate.

However, the period of a signal pattern to be used is in common among some wireless communication standards, and the number of variations in the period of a periodic signal for use in the preamble portion is comparatively smaller than the number of variations of the signal pattern. Accordingly, instead of the method using cross-correlation, an autocorrelation detector to a principal period is provided in a reception-side apparatus, so that the reception-side apparatus can widely detect an interference signal from a large variety of heterogeneous systems.

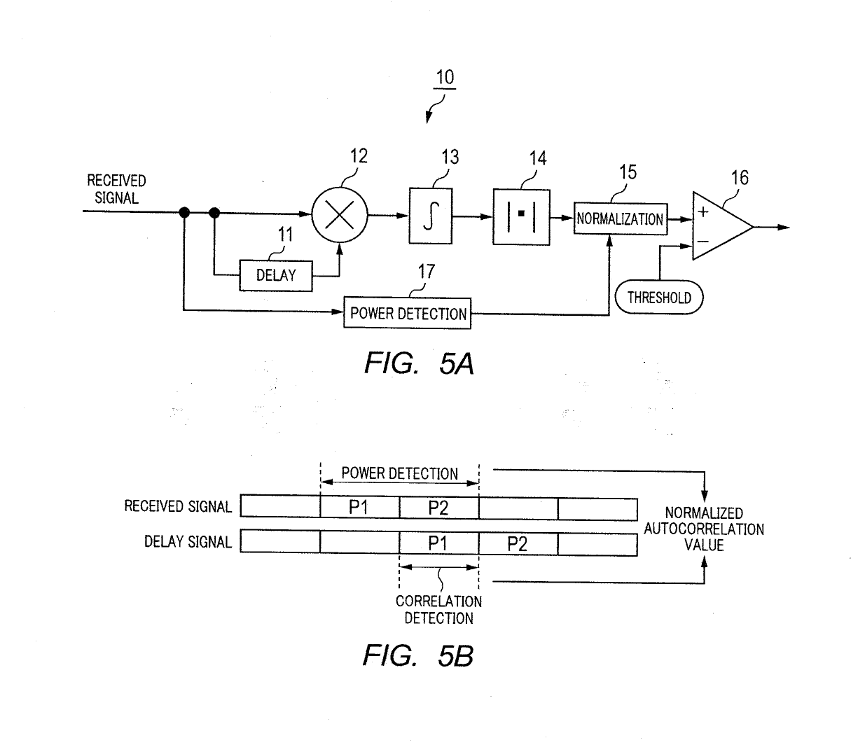

FIGS. 5A and 5B are diagrams illustrating an autocorrelation detector disclosed in PTL 2. FIG. 5A is a diagram showing the configuration of autocorrelation detector 10 in PTL 2. FIG. 5B is a diagram showing processing in the autocorrelation detector in the form of an image. In FIG. 5B, a first period portion of the periodic signal is represented by P1, and a second period portion is represented by P2.

As shown in FIG. 5B, the autocorrelation detector performs a correlation operation between a first signal corresponding to a received signal and a second signal obtained by delaying the first signal using delay section 11. The P1 portion and the P2 portion of the first signal and the P1 portion and the P2 portion of the second signal are subjected to correlation operation processing. However, since the second signal is given a delay for one period of the periodic signal, when computing the correlation between the first signal and the second signal, actually, the correlation between the P2 portion of the first signal and the P1 portion of the second signal is computed. Specifically, the correlation operation is performed such that the first signal is multiplied by the delayed second signal in multiplier 12, and the multiplication result obtained in multiplier 12 is integrated in integrator 13 for a predetermined duration. Accordingly, the correlation value is obtained.

Since the P1 portion and the P2 portion of the first signal and the P1 portion and the P2 portion of the second signal are subjected to correlation operation processing, a power observation duration for use in normalization becomes a duration which corresponds to both P1 and P2. That is, the correlation value is normalized by the average value of power during the power observation duration by power detection section 17 in normalization section 15, and the presence/absence of a signal is determined on the basis of the normalized correlation value in comparator 16.

A virtual carrier sense system in general disclosed in NPL 2 is used. For example, in order to detect a signal of the host system in a wireless LAN, the virtual carrier sense system transmits frame length information placed in a frame header of a signal, and a receiver extracts the frame length information from the signal to determine a frame duration. Even if reliability of carrier sense based on power is not sufficient, it is possible to detect the frame duration with high reliability by preamble detection and virtual carrier sense.

### <Additional Problem>

A carrier sense multiple access (CSMA) system which prevents collision between a plurality of transmission signals requires detection of the frame duration, so that, when a frame length is not constant, it is necessary to detect the frame duration.

However, although the autocorrelation detector disclosed in PTL 2 can detect the top of the frame, it is difficult for the autocorrelation detector to detect the end of the frame. That is, the unknown frame duration makes it difficult to establish CSMA.

In order to use virtual carrier sense disclosed in NPL 2, the receiver needs to demodulate a received signal and to decode the frame length information. In order to obtain the frame length information from signals of a large variety of heterogeneous systems, it is necessary to demodulate the signals of all target heterogeneous systems and to decode data. For this reason, it is impractical to apply the virtual carrier sense system to signal detection of heterogeneous systems.

Embodiment 3 aims at providing a signal detection apparatus and a signal detection method which detect a frame duration without demodulating a general signal including signals of a large variety of heterogeneous systems.

### <Description of Embodiment 3>

First, carrier sense will be described.

In carrier sense, power of a received signal is measured, and when the measured power value exceeds a predetermined threshold, it is recognized that a signal is detected. Carrier sense has a feature that a signal can be detected regardless of the types of systems. However, it may not be possible to distinguish between noise and a signal depending on the power.

For this reason, carrier sense has the following relationship. If the predetermined threshold is set to be low in order to improve detection sensitivity, wrong detection of noise as a signal is likely to occur. To the contrary, if the predetermined threshold is set to be high so as to prevent wrong detection, detection sensitivity is deteriorated. That is, there is a trade-off relationship between improvement of detection sensitivity and prevention of wrong detection.

Meanwhile, an on-going increase in transmission rate in recent wireless communication leads to an increase in use of multilevel modulation. In communication using multilevel modulation, data errors are likely to occur even with low interference. In order to effectively avoid interference, even low-level interference needs to be detected accurately.

For this reason, it is probably difficult with carrier sense having the trade-off relationship to satisfy the level of interference detection sensitivity required in receiving a signal modulated by multilevel modulation.

Accordingly, as a signal detection method having better signal detection sensitivity than carrier sense, there is technology which uses the correlation between the signals. Technology using the correlation is broadly classified into the following two methods. One method is a cross-correlation method which detects a detection-target signal on the basis of a correlation value of a preamble portion in a received signal and a known pattern signal candidate for use in the preamble portion. Another method is an autocorrelation method which detects a detection-target signal on the basis of a correlation value of preamble portions of a first signal and a second signal obtained by copying a received signal.

There are many cases where a periodic signal in which a specific signal pattern is repeated is used in the preamble portion. In the autocorrelation method, periodicity of a periodic signal is used for signal detection. While signal detection sensitivity of the autocorrelation method is low compared to cross-correlation detection, but high compared to carrier sense. The reason for high signal detection sensitivity of the autocorrelation method compared to carrier sense is that it is possible to distinguish between noise and a signal by periodicity of the periodic signal.

In the autocorrelation method, unlike the cross-correlation method, the reception side need not know the specific signal pattern. Accordingly, a reception-side apparatus can be realized with simple configuration. The autocorrelation method requires only detection of periodicity of a waveform, so that the reception signal processing in conformity with a symbol rate of an interference signal need not be performed. It is advantageous that the autocorrelation method is easily applied to signal detection of heterogeneous systems having different symbol rates or modulation systems.

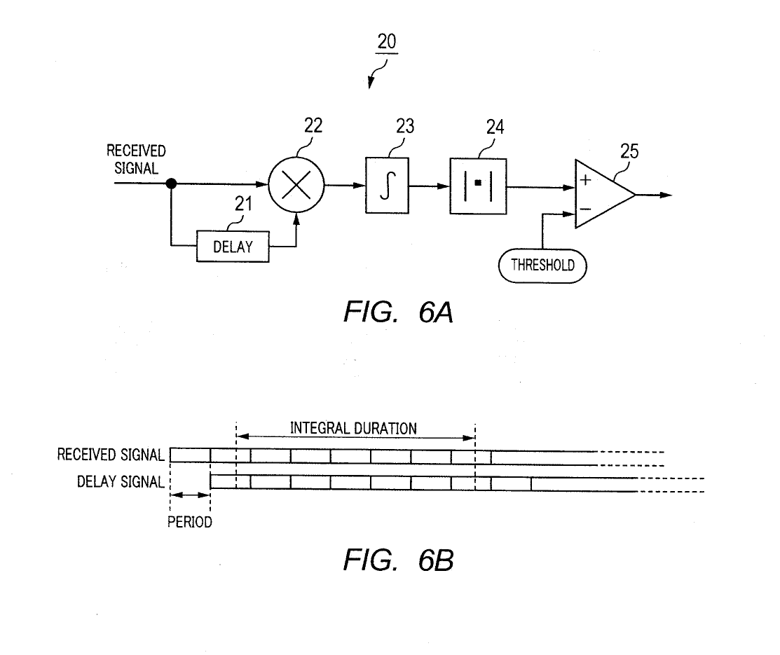

FIGS. 6A and 6B are diagrams illustrating a general autocorrelation method. FIG. 6A shows the basic configuration of autocorrelation detector 20, and FIG. 6B is a diagram showing processing of autocorrelation in the form of an image.

In autocorrelation detector 20 shown in FIG. 6A, of a first signal and a second signal distributed from a received signal, the second signal is delayed for a predetermined time by delay section 21. The predetermined time corresponds to a period of a periodic signal for use in a preamble portion of a detection-target signal.

The first signal is multiplied by the delayed second signal by multiplier 22. In autocorrelation detector 20 of FIG. 6A, although a simple multiplier is provided, a plurality of multipliers may be provided. This is because a complex baseband signal is used as a received signal, and a complex conjugate is multiplied.

The multiplication result obtained in multiplier 22 is integrated for a predetermined duration in integrator 23, and a correlation value is obtained.

An absolute value of the obtained correlation value is calculated by absolute value calculation section 24, the calculated absolute value of the correlation value and a predetermined threshold are compared in comparator 25, and a signal according to the comparison result is outputted.

The correlation value obtained from the complex baseband signal is a complex number. In an ideal state in which the period of the periodic signal for use in the preamble portion of the received signal matches a delay time given by the second signal in delay section 21, the obtained correlation value is a positive real number.

Meanwhile, for example, if phase rotation occurs due to an error factor of a clock deviation, the obtained correlation value may not be necessarily a positive real number. The correlation value obtained in integrator 23 is not used directly for determination, and the absolute value of the correlation value is used for determination. When it is ensured that an error factor is sufficiently small, a correlation component substantially matches a real number component, and an imaginary component is caused by, for example, noise. Instead of using the absolute value of the correlation value for determination, the real number component of the correlation value may be used for determination.

That is, the absolute value of the correlation value or the real number component of the correlation value is inputted to comparator 25 and is compared to the predetermined threshold. When the inputted value is greater than the predetermined threshold, it is determined that a signal is detected by the comparator.

In the autocorrelation detector, in order to reduce wrong detection as much as possible and to detect a weak signal with excellent sensitivity, it is necessary to appropriately set a threshold. Wrong detection means that, instead of the original detection-target signal, noise is wrongly detected as a detection-target signal.

In Embodiment 3 of the invention, it is assumed a situation in which a plurality of communication systems respectively corresponding to a plurality of millimeter-wave wireless communication standards are mixed. A transmitting apparatus (for example, an access point) of each communication system maps the periodic signal set in each communication system to the preamble portion and transmits the signal. The signal detection apparatus according to Embodiment 3 of the invention is installed in a receiving apparatus which communicates with any one of a plurality of communication systems, for example, a terminal apparatus.

The signal detection apparatus detects preamble signals from a plurality of communication systems (hereinafter, referred to “different systems”) other than a communication system (hereinafter, referred to as “host system”) with which the installed receiving apparatus communicates. Hereinafter, although a description will be provided assuming that the signal detection apparatus detects preamble signals of a plurality of different systems, the preamble signal of the host system may be included in the detection-target preamble signals.

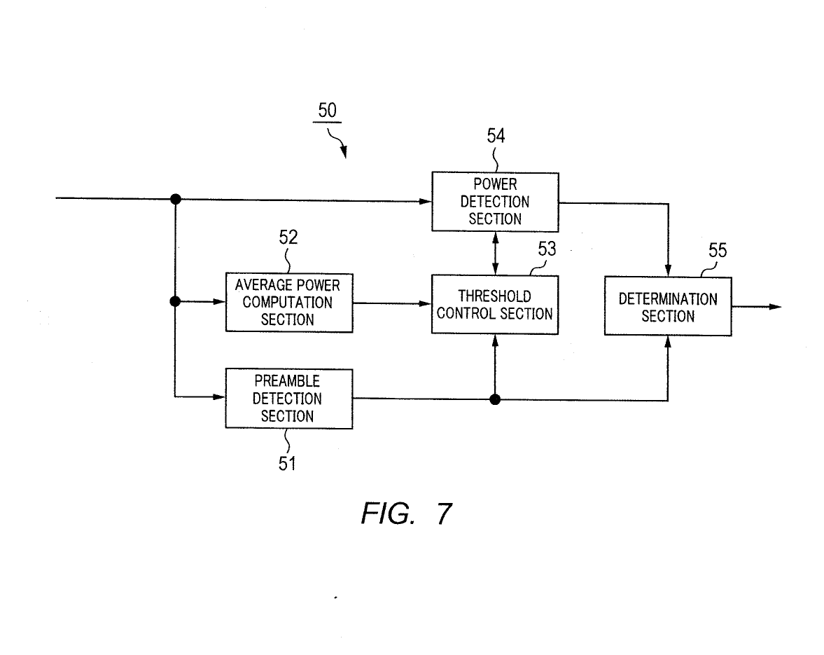

FIG. 7 is a block diagram showing the configuration of signal detection apparatus 50 according to Embodiment 3 of the invention. Signal detection apparatus 50 receives, as input, a received signal (that is, a baseband signal) obtained after a radio received signal received through an antenna in a receiving apparatus is subjected to radio reception processing (such as down-conversion and analog-digital conversion). Hereinafter, the configuration of signal detection apparatus 50 will be described referring to FIG. 7.

Preamble detection section 51 detects a preamble at the top of a frame, and a preamble detection signal is outputted to threshold control section 53 and determination section 55. In preamble detection section 51, although the autocorrelation detector shown in FIGS. 6A and 6B is suitable for signal detection of heterogeneous systems and is thus favorably used therefor, the invention is not limited to the detector. A different preamble detection section (for example, a cross-correlation detector) may be used.

Average power computation section 52 calculates the average power of input signals for the latest predetermined time, and outputs the calculated average power to threshold control section 53. The average time is set to the time sufficient to smooth variation in short time. The longer the average time is set, for example, the more the erroneous operation by instantaneous variation in noise is reduced, which makes it possible to set a threshold with precision. However, a response to change in signal is delayed in this case, so that the delay of the detection timing increases. Even worse, if the delay excessively increases, the CSMA operation fails. The average time is favorably set to about several times to several tens of times greater than the reciprocal of the bandwidth of the input signal. In regard to an operation to compute the average power, although an accurate average value for a predetermined period of time may be obtained, for example, a smoothing operation by a low-pass filter may be made.

Threshold control section 53 sets a threshold on the basis of the average power outputted from average power computation section 52. Specifically, before the preamble detection signal is inputted, threshold control section 53 sets a value obtained by adding a predetermined level margin (first level margin value) to the average power as a first threshold, and prevents wrong detection. This is an operation focused on reduction of wrong detection. The first threshold may be set to be infinite to substantially disable the detection operation.

Threshold control section 53 receives preamble detection signals as input, and when the average power of the input preamble detection signals is lower than the first threshold, a value obtained by subtracting a predetermined level margin (second level margin value) from the average power (power of the preamble portion) is set as a second threshold. This is an operation focused on detection sensitivity. The two thresholds are used, thereby achieving both improvement of detection sensitivity and reduction of wrong detection.

When notified by power detection section 54 that the signal power falls below the second threshold over a predetermined determination time, threshold control section 53 returns to the first threshold which is to be set before the preamble detection signal is inputted. The second threshold may be returned to the first threshold instantaneously or gradually in a stepwise manner or smoothly over a predetermined time. The threshold gradually changes, thereby preventing wrong ending of frame detection due to instantaneous variation in signal and thus performing stable frame detection.

Threshold control section 53 includes a timer which counts a predetermined time-out time. When the signal power does not fall over the time-out time from the preamble detection timing, threshold control section 53 returns the threshold from the second threshold to the first threshold which is to be set before the preamble detection signal is inputted. Accordingly, for example, it is possible to prevent the continuation of wrong detection for a long time due to variation in background noise level. It is preferable that the time-out time is set to about the maximum frame length which is usually used for a detection-target signal.

Power detection section 54 compares power of the input signal with a threshold to be controlled by threshold control section 53, and when power is greater than the threshold, outputs a power detection signal to determination section 55. When the power of input signal falls below the second threshold over a predetermined determination time, power detection section 54 notifies threshold control section 53, accordingly. When the signal power falls below the second threshold over a predetermined determination time, this means that the frame duration ends, so that it is possible to detect the frame duration.

Determination section 55 outputs a logical sum of the preamble detection signal outputted from preamble detection section 51 and the power detection signal outputted from power detection section 54 as a detection determination signal. That is, if one or both of a preamble and power are detected, it is determined that a signal is detected. This operation is effective in the following case.

In threshold control section 53, the time until an appropriate threshold is calculated after a preamble is detected is required. This is because it takes time for an average operation to accurately measure power of the preamble portion or for computation. Accordingly, the rising edge of the power detection signal is delayed from the preamble detection timing This delay time is not negligible, and for example, when the CSMA operation fails, the logical sum of the power detection signal and the preamble detection signal is used, thereby determining signal detection by the preamble detection signal without depending on the power detection signal in which a delay occurs.

Determination section 55 may include the same time-out processing as the time-out time of threshold control section 53. That is, determination section 55 may forcibly invalidate the detection determination signal after a predetermined time elapses from the preamble detection timing.

Determination section 55 may forcibly invalidate the detection determination signal before a preamble is detected, after the falling edge of the power detection signal, and after the time-out time elapses. This is the same operation as an operation in which the first level margin is set to be infinite in threshold control section 53.

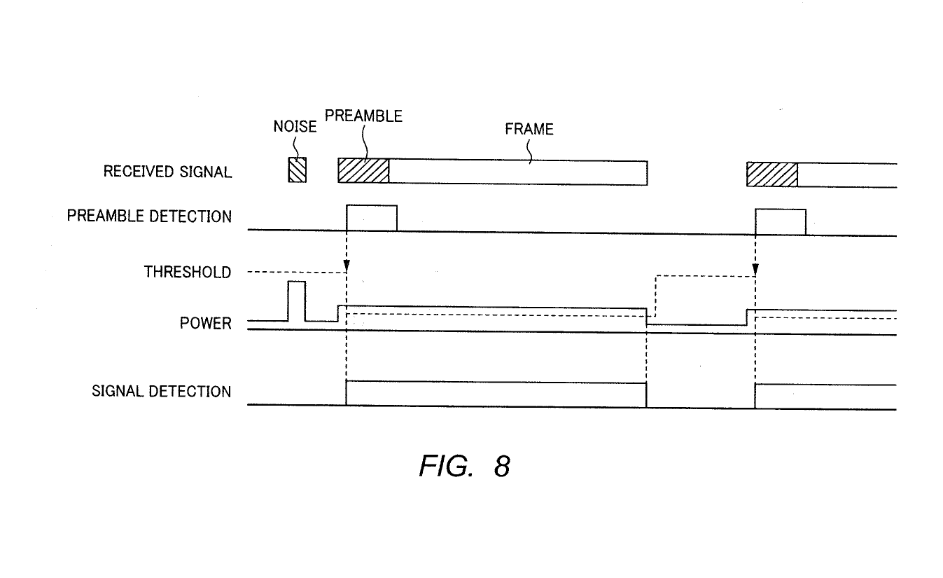

Next, the signal detection operation of signal detection apparatus 50 will be described referring to FIG. 8. Before a preamble is detected, the first threshold obtained by adding the first level margin value to the average power is set. For this reason, even if noise is generated, since power of noise is less than the first threshold, no signal detection is performed, thereby making it possible to prevent wrong detection.

Subsequently, when a preamble is detected and the average power of the preamble is lower than the first threshold, since the second threshold obtained by subtracting the second level margin value from the average power (power of the preamble portion) is set, it is possible to improve detection sensitivity.

When the signal power falls below the second threshold over a predetermined determination time, it is determined that the frame duration ends, and the threshold is changed from the second threshold to the first threshold.

According to Embodiment 3, before preamble detection, the first threshold obtained by adding the first level margin value to the average power of the input signal is set, and when the average power is lower than the first threshold after preamble detection, the second threshold obtained by subtracting the second level margin value from the average power is set. In addition, when the signal power falls below the second threshold over a predetermined determination time, it is determined that the frame duration ends, thereby making it possible to achieve both improvement of detection sensitivity and reduction of wrong detection without demodulating a general signal including signals of a large variety of heterogeneous systems and to detect the frame duration.

Although Embodiment 3 has been described assuming that the preamble detection section which detects a preamble at the top of a frame is provided, instead of the preamble detection section, a characteristic signal detection section which detects a different characteristic signal in the vicinity of the top of a frame may be provided. As a characteristic signal, for example, a unique word, a synchronization signal, or a frame header for frame capturing may be used.

### <Outline of the Disclosure>

The outline of a signal detection apparatus and a signal detection method of the disclosure will be listed below.

### [Disclosure 1]

A signal detection apparatus includes: a preamble detection section that detects a preamble portion provided at the top portion of a frame of a received signal; a power detection section that detects power of the received signal exceeding a variable threshold; and a threshold control section that controls the variable threshold on the basis of the detection of the preamble portion, in which, when power of the received signal falls below the variable threshold set when the preamble portion is detected over a predetermined determination time, the power detection section determines that the duration of the frame ends.

### [Disclosure 2]

In the signal detection apparatus described in Disclosure 1, the preamble portion is a periodic signal.

### [Disclosure 3]

In the signal detection apparatus described in Disclosure 1, the preamble detection section detects the preamble portion using autocorrelation.

### [Disclosure 4]

The signal detection apparatus described in Disclosure 1 further includes: a determination section that defines a logical sum of a received signal of power exceeding the variable threshold and the detected preamble portion as a detection determination signal.

### [Disclosure 5]

In the signal detection apparatus described in Disclosure 4, the determination section invalidates the detection determination signal after a predetermined time elapses from a detection timing of the preamble portion.

### [Disclosure 6]

In the signal detection apparatus described in Disclosure 1, the threshold control section sets the variable threshold as a first threshold before the preamble portion is detected, and sets the variable threshold as a second threshold when the preamble portion is detected and the average power of the received signal is lower than the first threshold.

### [Disclosure 7]

In the signal detection apparatus described in Disclosure 6, when the average power of the received signal falls below the second threshold over a predetermined determination time after the variable threshold is set as the second threshold, the threshold control section returns the variable threshold to the first threshold which is to be set before the preamble portion is detected.

### [Disclosure 8]

The signal detection apparatus described in Disclosure 7, in which the threshold control section gradually changes the threshold from the second threshold to the first threshold.

### [Disclosure 9]

A signal detection method includes: detecting a preamble portion provided at the top of a frame of a received signal; detecting power of the received signal exceeding a variable threshold; and controlling the variable threshold based on the detection of the preamble portion, in which, when power of the received signal falls below the variable threshold set when the preamble portion is detected over a predetermined determination time during the detection of power, it is determined that the duration of the frame ends.

According to the disclosure, it is possible to detect the frame duration without demodulating a general signal including signals of a large variety of heterogeneous systems.

Although in the foregoing embodiments, a case where the invention is constituted by hardware has been described as an example, the invention may be realized by software in collaboration with hardware.

The functional blocks used in the descriptions of the above-noted embodiments are typically implemented by LSI devices, which are integrated circuits. These may be individually implemented as single chips and, alternatively, a part or all thereof may be implemented as a single chip. The term LSI devices as used herein, depending upon the level of integration, may refer variously to ICs, system LSI devices, very large-scale integrated devices, and ultra-LSI devices.

The method of integrated circuit implementation is not restricted to LSI devices, and implementation may be done by dedicated circuitry or a general-purpose processor. After fabrication of an LSI device, a programmable FPGA (field-programmable gate array) or a re-configurable processor that enables reconfiguration of connections of circuit cells within the LSI device or settings thereof may be used.

Additionally, in the event of the appearance of technology for integrated circuit implementation that replaces LSI technology by advancements in biotechnology technology or technologies derivative therefrom in the feature, the present invention can be applied with the technology.

The disclosures of specifications, the drawings, and abstracts of Japanese Patent Application No. 2012-058608, filed on Mar. 15, 2012 and Japanese Patent Application No. 2012-067343, filed on Mar. 23, 2012 are incorporated herein by reference in their entirety.

### INDUSTRIAL APPLICABILITY

The signal detection apparatus and signal detection method according to the invention can be applied to a receiving apparatus configured to communicate with at least one of a plurality of communication systems, such as a terminal apparatus.

### REFERENCE SIGNS LIST

101 Power detection section

102 Storage section

103 Multiplier

104 Integrator

105 Absolute value calculation section

106 Determination section

51 Preamble detection section

52 Average power computation section

53 Threshold control section

54 Power detection section

55 Determination section

1. A signal detection apparatus comprising:
a power detection section that detects a received signal of reception power exceeding a predetermined first threshold;
a correlation value calculation section that calculates a correlation value of the detected first received signal and a second received signal detected next to the first received signal;
an absolute value calculation section that calculates an absolute value of the calculated correlation value; and
a determination section that determines the presence or absence of a detection-target signal based on a threshold determination of the calculated absolute value of the correlation value and a predetermined second threshold.

2. The signal detection apparatus according to claim 1, wherein the determination section determines that the detection-target signal is detected when the absolute value of the correlation value is equal to or greater than the second threshold.

3. The signal detection apparatus according to claim 1, wherein the received signal is a beacon.

4. The signal detection apparatus according to claim 1, wherein the received signal is a beacon to which beam-forming is applied.

5. A signal detection method comprising:
detecting reception power exceeding a predetermined first threshold;
calculating a correlation value of a first received signal of the detected reception power and a second received signal of reception power detected next to the first received signal;
calculating an absolute value of the calculated correlation value; and
determining the presence or absence of a detection-target signal based on a threshold determination of the calculated absolute value of the correlation value and a predetermined second threshold.
